(19) United States
(12) Patent Application Publication
(10) Pub. No.: US 2007/0224501 A1
(43) Pub. Date: Sep. 27, 2007

(54) Battery can and battery using the can and method of fabricating the can

(76) Inventor: Heuisang Yoon, Yongin-si (KR)

Correspondence Address: Robert E. Bushnell, Suite 300, 1522 K Street, N. W., Washington, DC, 20005-1202, US

(21) Appl. No.: 11/724,275

(22) Filed: Mar. 15, 2007

(30) Foreign Application Priority Data
Mar. 27, 2006 (KR) 10-2006-0027530

(51) Int. Cl. H01M 2/02; H01M 10/50; H01M 2/08; B32B 1/02

(52) U.S. Cl. 429/176; 429/62; 29/623.5; 29/623.2; 429/174; 428/603

(57) ABSTRACT

A battery can, for example, a can for a lithium rechargeable battery, having at least one bottom groove for facilitating insertion and extraction to and from equipment is arranged on a bottom surface of the can, the can having a predetermined space for accommodating an electrode assembly through a top opening of the can, the electrode assembly including a positive plate, a negative plate and a separator disposed between the positive plate and the negative plate.

### CLAIM OF PRIORITY

This application makes reference to, incorporates the same herein, and claims all benefits accruing under 35 U.S.C. §119 from an application earlier filed in the Korean Intellectual Property Office on Mar. 27, 2006 and there duly assigned Serial No. 10-2006-27530.

### BACKGROUND OF THE INVENTION

1. Field of the Invention

The present invention relates to a battery can, for example, a can for a lithium rechargeable battery and a battery using the can and a method of fabricating the can and, more particularly, the present invention relates to such a battery can, for example, a can for a lithium rechargeable battery and a battery using the can and a method of fabricating the can that maximizes the capacity of the battery by directly insulating the bottom surface of the can and forming a fixing groove for facilitating insertion and extraction to and from equipment, rather than forming a bottom cover attached to the can to ensure the insulation of the bottom surface of the can and to facilitate the insertion and extraction to and from equipment.

2. Discussion of Related Art

In general, as light-weight and high-functionality portable electronic equipment, such as video cameras, portable phones, portable computers, etc have continued to progress, considerable research has been performed on rechargeable batteries used as power sources. Such rechargeable batteries include nickel-cadmium batteries, nickel-metal hydride batteries, nickel-zinc batteries, lithium rechargeable batteries, etc. Among them, the lithium rechargeable battery that can be made small in size with a high capacity has been widely used in the field of high-tech electronic equipment due to its advantages, such as high operating voltage and high energy density per unit weight.

FIG. 1 is a perspective view of an inner pack lithium rechargeable battery.

The lithium rechargeable battery 100 includes a bare cell 105, a top cover 180 and a bottom cover 190.

The bare cell 105 is formed in such a manner that an electrode assembly including a positive plate, a negative plate and a separator is enclosed along with an electrolyte in a can and a top opening of the can is sealed by a cap assembly.

The can is generally made of aluminum or an alloy thereof by a deep drawing process. The respective surfaces of the can are formed in a plane shape in general.

The electrode assembly is wound after arranging the separator between the positive plate and the negative plate. Both a positive tab connected to the positive plate and a negative tab connected to the negative plate protrude on the upper end of the electrode assembly. The positive tab and negative tab are spaced apart to be electrically insulated from each other. The positive tab and negative tab are generally made of nickel.

The cap assembly includes a cap plate, an insulating plate, a terminal plate and an electrode terminal. The cap assembly is attached to the top opening of the can along with a separate insulating case to seal the can.

The top cover 180 is arranged on the top of the bare cell 105. The top cover 180 including a protection circuit substrate (not shown) and external terminals 182 generally formed by an injection molding process using hot-melt resin.

The bottom cover 190 is provided on the bottom of the bare cell 105 to prevent the bottom surface of the can from being exposed externally. A groove for facilitating insertion and extraction to and from equipment can be arranged on the bottom surface of the bottom cover.

Recently, since cellular phones, Digital Multimedia Broadcasting (DMB) terminals and the like having multi-functions have been merchandised, considerable research and development on high capacity lithium rechargeable batteries has been performed. The high capacity of the lithium rechargeable battery can be achieved by developing a new electrode material or by optimizing the structure thereof. The bottom cover in the can type lithium rechargeable battery is arranged to prevent the bottom surface of the can from being exposed externally, to prevent a short circuit, and to include a groove for facilitating the insertion and extraction to and from the equipment. However, such a bottom cover having a thickness of about 0.8 to 1.0 mm has a drawback in that it reduces the capacity of the bare cell due to its thickness.

### SUMMARY OF THE INVENTION

Accordingly, the present invention has been contrived to solve the above-described drawbacks, and an object of the present invention is to provide a battery can, for example, a can for a lithium rechargeable battery and a lithium rechargeable battery using the can and a method of fabricating the can that maximizes the capacity of the battery by directly insulating the bottom surface of the can and forming a fixing groove for facilitating insertion and extraction to and from the equipment, rather than forming a bottom cover attached to the can to ensure the insulation of the bottom surface of the can and to facilitate the insertion and extraction to and from the equipment.

To accomplish one object of the present invention, a battery can is provided including: a predetermined space for accommodating an electrode assembly through a top opening of the can, the electrode assembly including a positive plate, a negative plate and a separator arranged between the positive plate and the negative plate; and at least one bottom groove for facilitating insertion and extraction to and from equipment, the at least one bottom groove being arranged on a bottom surface of the can.

The at least one bottom groove is preferably arranged in parallel to a long edge of the can.

The battery can preferably further includes long lateral sides, short lateral sides and a lower plate and has a box shape.

A horizontal section of the can preferably has an elliptical shape with the short lateral sides having a curved surface shape.

The battery can preferably further includes a lateral recess arranged on a lateral side of the can to receive a label. The lateral recess preferably has a depth in a range of 0.05 mm to 0.2 mm. The lateral recess is preferably stepped with respect to upper and lower parts of the can.

To accomplish another object of the present invention, a battery is provided including: a bare cell including an electrode assembly, a can to accommodate the electrode assembly and a cap assembly to seal a top opening of the can; a hot-melt section including a protection circuit electrically connected to the bare cell; and an insulating layer coated on a bottom surface of the bare cell, the insulating layer including an insulating material.

The hot-melt section is preferably arranged on the top of the bare cell to serve as a top cover.

The insulating layer is preferably coated on a bottom surface of the bare cell by either a spray process or a dipping process.

The battery preferably further includes at least one bottom groove arranged on a bottom surface of the bare cell to facilitate insertion and extraction to and from equipment. The at least one bottom groove is preferably arranged in parallel to a long edge of the can.

The battery preferably further includes a lateral recess arranged on a lateral side of the can to receive a label. The lateral recess preferably has a depth in a range of 0.05 mm to 0.2 mm in depth and is preferably stepped with respect to upper and lower parts of the can.

To accomplish yet another object of the present invention, a method of fabricating a battery is provided, the method including: forming a bottom groove on a bottom surface of a can to facilitate insertion and extraction to and from equipment; inserting an electrode assembly including a bare cell into an inside of the can; injecting an electrolyte into the inside of the can; forming an insulating layer on the bottom surface of the can; and forming a hot-melt section on a top of the can to seal the can, the hot-melt section including a protection circuit electrically connected to the bare cell.

The method preferably further includes forming a lateral recess on a lateral side of the can to receive a label.

Forming an insulating layer preferably includes either a spray process or a dipping process.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of an inner pack lithium rechargeable battery;

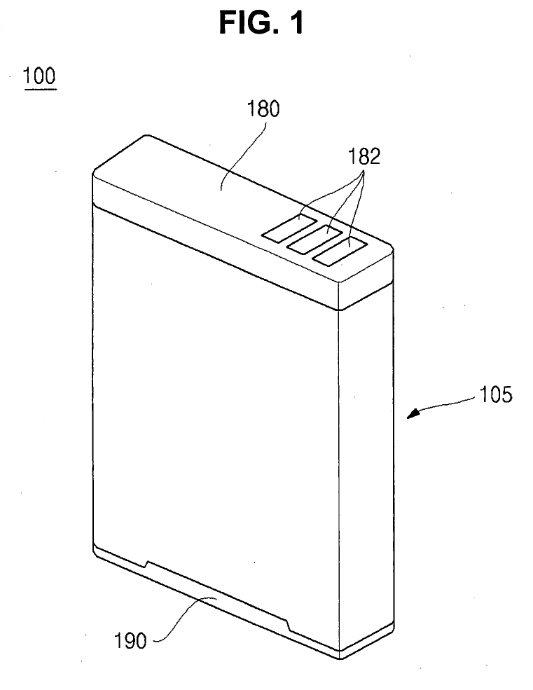

FIG. 2a is a perspective view, viewing from the top side of a lithium rechargeable battery in accordance with an exemplary embodiment of the present invention;

FIG. 2b is a perspective view, viewing from the bottom side of the lithium rechargeable battery in accordance with the exemplary embodiment of the present invention;

FIG. 2c is a vertical sectional view of FIG. 2a;

FIG. 2d is an exploded perspective view of a cap assembly in FIG. 2a;

FIG. 3a is a perspective view, viewing from the top side of a lithium rechargeable battery in accordance with another exemplary embodiment of the present invention;

FIG. 3b is a perspective view, viewing from the bottom side of the lithium rechargeable battery in accordance with another exemplary embodiment of the present invention;

FIG. 3c is a vertical sectional view of FIG. 3a;

FIG. 4a is a perspective view, viewing from the top side of a lithium rechargeable battery in accordance with still another exemplary embodiment of the present invention;

FIG. 4b is a perspective view, viewing from the bottom side of the lithium rechargeable battery in accordance with still another exemplary embodiment of the present invention; and

FIG. 4c is a front view of FIG. 4a.

### DETAILED DESCRIPTION OF THE INVENTION

Hereinafter, exemplary embodiments according to the present invention is described with reference to the accompanying drawings. A hot-melt section including a protection circuit is described below by citing an example in which it is formed on the top of a bare cell in the form of a top cover. However, the hot-melt section can also be arranged on the side of the bare cell. Accordingly, the position of the hot-melt section is not limited thereto.

First, a lithium rechargeable battery in accordance with an exemplary embodiment is described as follows.

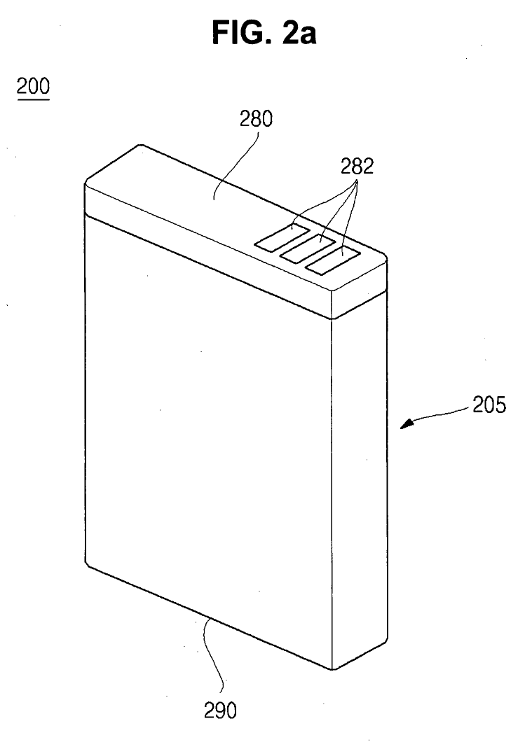

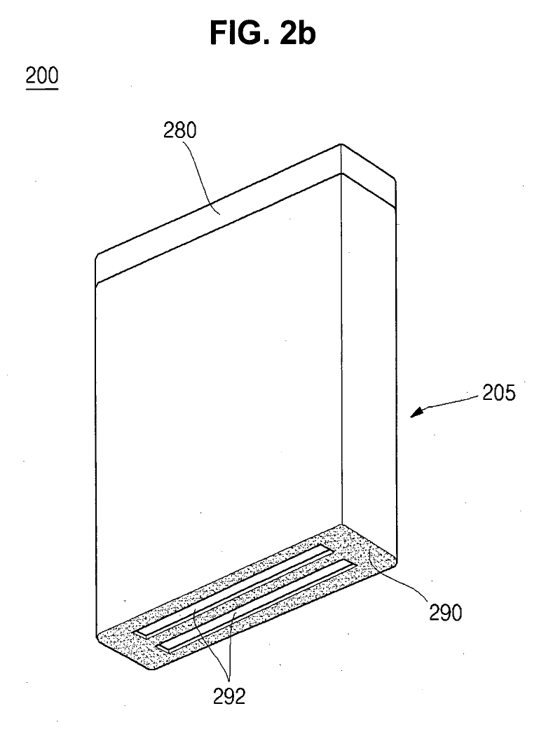

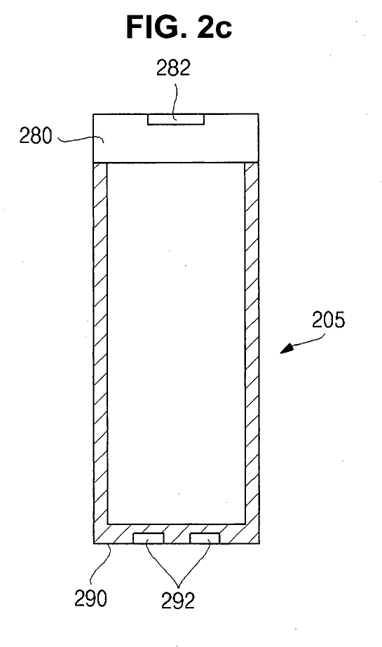

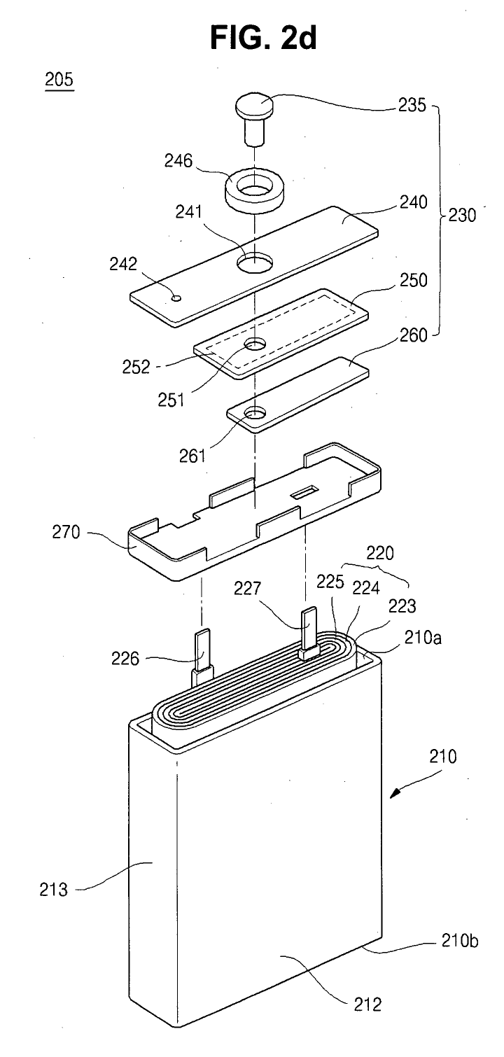

FIG. 2a is a perspective view, viewing from the top side of a lithium rechargeable battery in accordance with an exemplary embodiment of the present invention, FIG. 2b is a perspective view, viewing from the bottom side of the lithium rechargeable battery in accordance with the exemplary embodiment of the present invention, FIG. 2c is a vertical sectional view of FIG. 2a, and FIG. 2d is an exploded perspective view of a cap assembly in FIG. 2a.

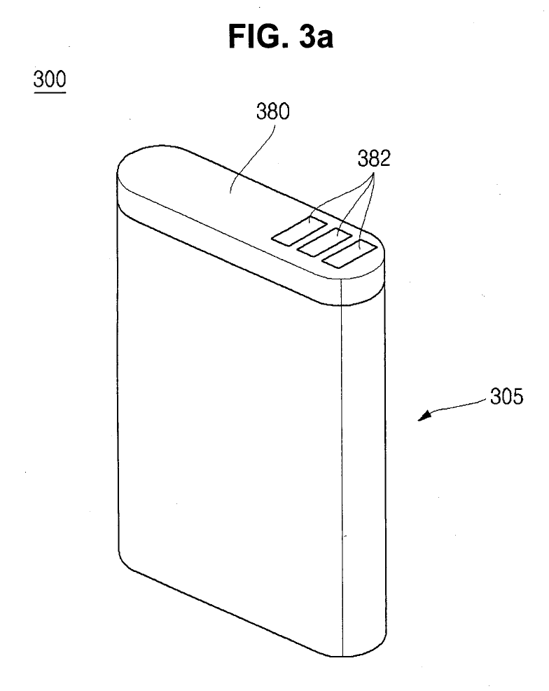

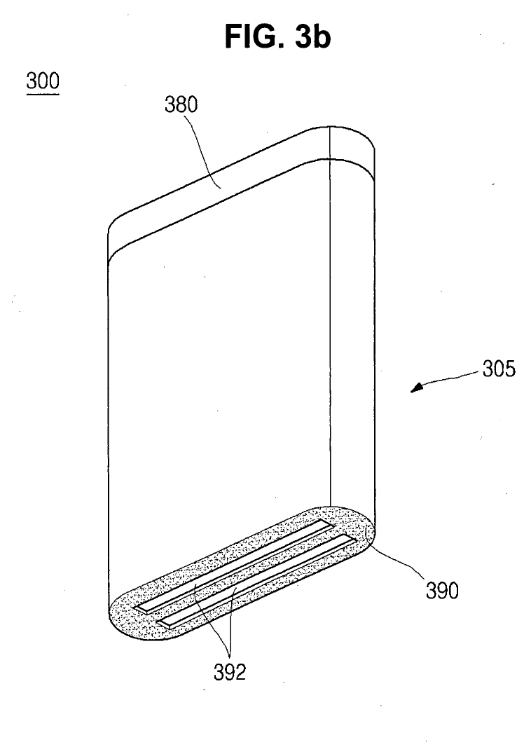

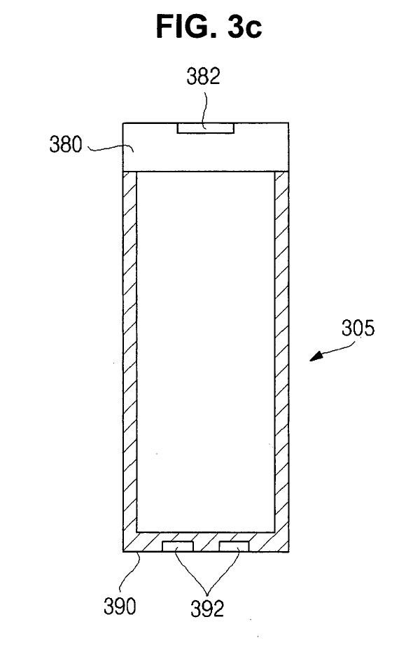

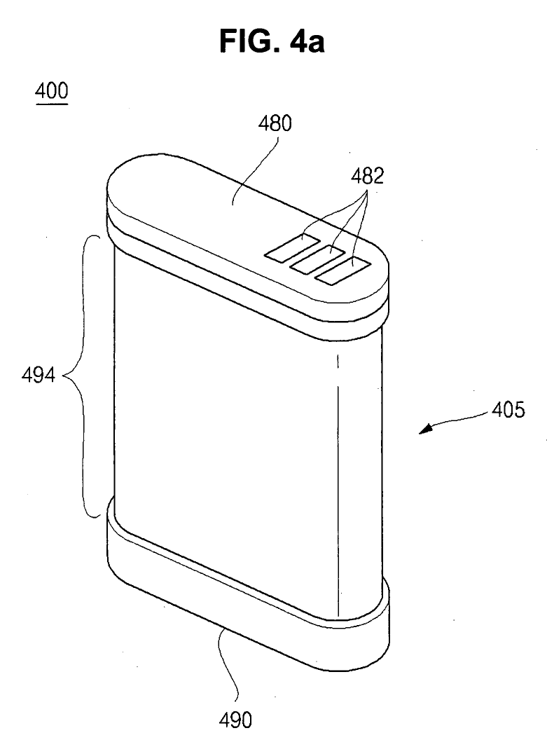

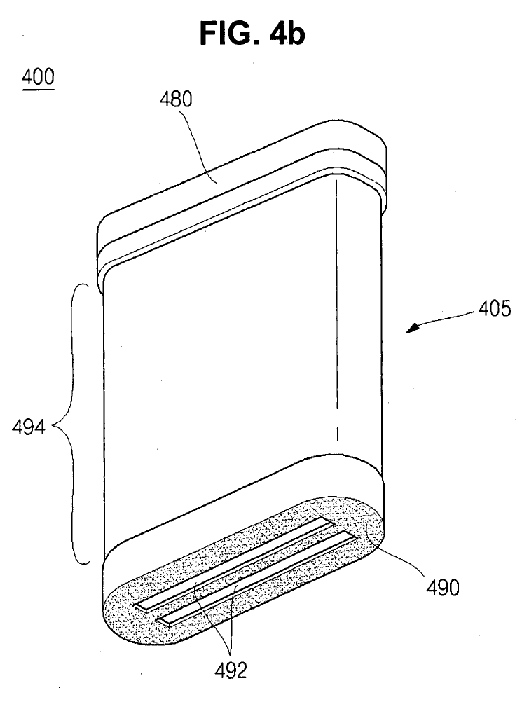

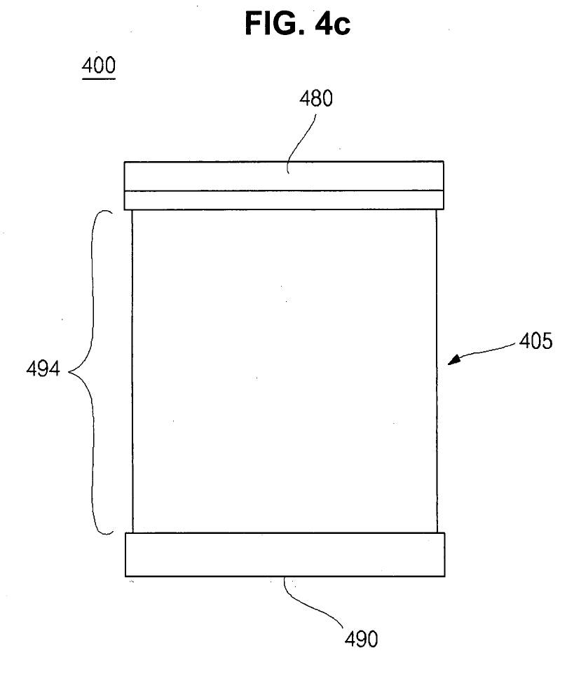

Referring to FIG. 2a, the lithium rechargeable battery 200 in accordance with an exemplary embodiment of the present invention includes a bare cell 205, a top cover 280 and an insulating layer 290. Since the insulating layer 290 is established in the form of a thin film in a spray process or a dipping process, it is set forth that the shape of the insulating layer 290 is not depicted in FIGS. 2a and 2b that are shown in a large scale, but its position is designated only, which is the same as the embodiments depicted in FIGS. 3a and 4a.

Referring to FIG. 2d, the bare cell 205 is configured in such a manner that an electrode assembly 220 including a positive plate 223, a negative plate 225 and a separator 224 is accommodated along with an electrolyte in a can 210 and then a top opening 210a of the can 210 is sealed up with a cap assembly 230. The bare cell 205 is generally made in a substantially rectangular box shape. The bare cell 205 includes a front side 212 and a rear side formed facing each other and having long edges, both lateral sides 213 facing each other and having short edges, an upper side on which a cap plate 240 is positioned and a lower side 210b opposite to the upper side.

The electrode assembly 220 is formed wound after arranging the separator 224 between the positive plate 223 and the negative plate 225.

The positive plate 223 includes a positive current collector made of a metal thin plate having excellent conductivity, e.g., aluminum foil, and a positive active material layer coated on both sides thereof. Lithium oxides, such as LiCoO₂, LiMn₂O₄, LiNiO₂, LiMnO₂, etc. have been used as the positive active material. A positive uncoated portion, i.e., a positive current collecting area, on which the positive active material layer is not formed, is arranged on both ends of the positive plate 223. A positive tab 226 made of aluminum and protruding on the upper part of the electrode assembly 220 by a predetermined length is attached to one end of the positive uncoated portion.

The negative plate 225 includes a negative current collector made of a conductive metal thin plate, e.g., copper or nickel foil, and a negative active material layer coated on both sides thereof. A negative uncoated portion, i.e., a negative current collecting area, on which the negative active material layer is not formed, is arranged on both ends of the negative plate 225. A negative tab 227 made of nickel and protruding on the lower part of the electrode assembly 220 by a predetermined length is attached to one end of the negative uncoated portion. Moreover, an insulating plate for preventing the contact with the can 210 can be further included on the lower part of the electrode assembly 220.

The separator 224 is arranged between the positive plate 223 and the negative plate 225 and can extend to surround the outer circumferential surface of the electrode assembly 220. The separator 224 is made of a porous polymer material so as to prevent a short circuit between the positive plate 223 and the negative plate 225 and to transmit lithium ions.

The can 210 is formed in a substantially rectangular box shape including a pair of long lateral sides 212 having a substantially rectangular shape, a pair of short lateral sides 213 and a lower plate 210b. The upper part of the can 210 is opened to form a top opening 210a, through which the electrode assembly 220 is inserted. Moreover, an electrolyte that enables the transfer of lithium ions is injected into the electrode assembly 220. Light aluminum is mainly used as a material of the can 210. The upper part of the can 210 is sealed by the cap assembly 230 to prevent the electrolyte from leaking out. The thickness of the long lateral side 212 and the short lateral side 213 is about 0.2 to 0.4 mm and the thickness of the lower plate 210b is about 0.2 to 0.7 mm. However, the thickness of the long lateral side 212 and the short lateral side 213 is not limited thereto. The can 210 can be formed by a deep drawing process, and the long lateral sides 212, the short lateral sides 213 and the lower plate 210b are formed in a body. However, the forming process of the can 210 is not limited thereto.

A bottom groove 292 is arranged on the bottom surface (hereinafter referred to as the bottom surface) of the lower plate 210b of the can 210. The bottom groove 292 is formed to facilitate insertion and extraction to and from equipment, such as cellular phones, camcorders, etc. Since external terminals 282 are provided on the top cover 280 of the lithium rechargeable battery 200, the bottom surface is not coupled to the equipment. Accordingly, an insulating layer 290 is established on the bottom surface to prevent a short circuit. Since the lithium rechargeable battery 200 needs to be affixed to the equipment, it is preferable for an affixing means, such as the bottom groove 292, to be formed. It is natural that a projection having a shape corresponding to the bottom groove 292 be arranged on the equipment.

As can be seen from FIGS. 2b and 2c, at least one bottom groove 292 is established in a direction parallel to the long edge. However, the number of bottom grooves 292 is not limited hereto. Moreover, the plane shape of the bottom groove 292 can be any shape selected from a rectangle, an ellipse, a circle and a polygon. However, the plane shape of the bottom groove 292 is not limited thereto, since it can be varied according to the shape of the projection of the equipment. Since the width and the depth of the bottom groove 292 can be varied according to circumstances, their standards are not limited herein. In addition, the bottom groove 292 is preferably formed by a pressing process; however, the forming process of the bottom groove 292 is not limited herein. The bottom groove 292 is connected to the projection of the equipment to affix the lithium rechargeable battery 200 and plays a role of facilitating insertion and extraction to and from the equipment.

The cap assembly 230 includes a cap plate 240, an insulating plate 250, a terminal plate 260 and an electrode terminal 235. The cap assembly 230 connected to a separate insulating case 270 is attached to the top opening 210a of the can 210 to seal the can 210.

The cap plate 240 is welded to the top opening 210a of the can 210 to seal the can 210. The cap plate 240 has an electrolyte injection hole 242 arranged on one side thereof. The electrolyte injection hole 242 is pressed in by means of a ball and the like and then welded. A terminal through-hole 241 is formed in about the middle of the cap plate 240 and the electrode terminal 235 insulated by a gasket tube 246 is inserted through the terminal through-hole 241.

The insulating plate 250 is made of an insulating material identical to the gasket and attached to the bottom surface of the cap plate 240. The insulating plate 250 includes a terminal through-hole 251, through which the electrode terminal 235 is inserted, arranged at a position corresponding to the terminal through-hole 241 of the cap plate 240. A receiving recess 252 corresponding to the size of the terminal plate 260 is provided on the bottom surface of the insulating plate 250 to receive the terminal plate 260.

The terminal plate 260 is generally made of a Ni alloy and attached to the bottom surface of the insulating plate 250. The terminal plate 260 includes a terminal through-hole 261, through which the electrode terminal 235 is inserted, established at a position corresponding to the terminal through-hole 241 of the cap plate 240. Since the electrode terminal 235 insulated by the gasket tube 246 is connected with the terminal plate 260 through the terminal through-hole 241 of the cap plate 240, the terminal plate 260 is electrically insulated from the cap plate 240 and electrically coupled to the electrode terminal 235.

A negative tab 227 connected to the negative plate 225 is welded to one side of the terminal plate 260 and a positive tab 226 connected to the positive plate 223 is welded to the other side of the cap plate 240. The welding method for connecting the negative tab 227 and the positive tab 226 includes resistance welding, laser welding, etc. However, resistance welding is generally used.

The electrode terminal 235 is connected to the negative tab 227 of the negative plate 225 or the positive tab 226 of the positive plate 223 to act as a negative terminal or a positive terminal.

The top cover 280 is arranged on the top of the bare cell 205. The top cover 280 includes a protection circuit, (not shown), electrically connected to the bare cell 205 and desirably formed by an injection molding process using a hot-melt resin. However, the method of forming the top cover 280 is not limited herein. The protection circuit is formed on a protection circuit substrate (not shown), and protects the bare cell 205 from the risk of an overcharge or an overcurrent. The protection circuit is electrically coupled to the electrode terminal 235 and the cap plate 240 through a lead. External terminals 282 are exposed to the outside to be electrically connected to the equipment on the top surface of the top cover 280.

The insulating layer 290 is arranged on the bottom surface of the bare cell 205. The insulating layer 290 is formed over the entire surface including the portion where the bottom groove 292 is formed and the portion other than the bottom groove 292. Since the lithium rechargeable battery 200 includes the positive and negative external terminals 282 arranged on the top thereof, the bottom of the lithium rechargeable battery 200 is not used to electrically couple the battery to the equipment. Accordingly, it is necessary that the bottom surface of the lithium rechargeable battery 200 be protected from the risk of a short circuit and the insulating layer 290 covers the bottom surface so that the bottom surface of the bare cell 205 is not exposed directly to the outside. It is desirable for the insulating layer 290 coming in contact with the equipment to be in the form of a thin film. Accordingly, it is preferable for the insulating layer 290 to be formed by a spray process or a dipping process. The spray process is a process for spraying an insulating material, such as paint, plastic, rubber, etc. on the bottom surface of the bare cell 205. According to the spray process, the insulating layer 290 can be formed as a thin film of a micrometer (μm) thickness. The dipping process is achieved by dipping the bottom surface of the bare cell 205 into paint, melted resin or melted rubber. In order to thinly form the insulating layer 290 through the dipping process, it is preferable for the bottom surface of the bare cell 205 to be dipped and taken out and inclined and left as is for a sufficient time.

A lithium rechargeable battery in accordance with another exemplary embodiment of the present invention is described below.

FIG. 3a is a perspective view, viewing from the top side of the lithium rechargeable battery in accordance with another exemplary embodiment of the present invention, FIG. 3b is a perspective view, viewing from the bottom side of the lithium rechargeable battery in accordance with another exemplary embodiment of the present invention, and FIG. 3c is a vertical sectional view of FIG. 3a. Since the lithium rechargeable battery of the embodiment depicted in FIG. 3a is substantially identical with that of FIG. 2a except for the fact that the short lateral sides are formed in a smooth curve, a description follows only on the differences therebetween.

Referring to FIG. 3a, the lithium rechargeable battery 300 in accordance with another exemplary embodiment of the present invention includes a bare cell 305, a top cover 380 and an insulating layer 390. Since the top cover 380 and the insulating layer 390 have been described sufficiently in the embodiment of FIG. 2a, a detailed description thereof has been omitted.

The bare cell 305 includes an electrode assembly, a can and a cap assembly. The bare cell 305 is formed in a substantially elliptic cylindrical shape as the short lateral sides are formed in a smooth curved surface. Since the electrode assembly and the cap plate have been described sufficiently in the embodiment of FIG. 2a, a detailed description thereof has been omitted.

The can is formed in a substantially elliptic cylindrical shape including a pair of long lateral sides opposite to each other in a substantially rectangular plane shape, a pair of short lateral sides opposite to each other in a curved surface shape, and a lower plate in an elliptical shape. Since the short lateral sides formed in a curved surface having a predetermined curvature are connected to the long lateral sides, the boundary between the short lateral sides and the long lateral sides is not explicitly shown.

A bottom groove 392 is established on the bottom surface of the can and an insulating layer 390 is provided thereon to prevent a short circuit. As can be seen from FIGS. 3b and 3c, at least one bottom groove 392 is arranged in a direction parallel to the long edge. However, the number of bottom grooves 392 is not limited thereto. The plane shape of the bottom groove 392 can be a rectangle, an ellipse, a circle and a polygon. However, the plane shape of the bottom groove 392 is not limited thereto.

A lithium rechargeable battery in accordance with another exemplary embodiment of the present invention is described below.

FIG. 4a is an upper perspective view of the lithium rechargeable battery in accordance with another exemplary embodiment of the present invention, FIG. 4b is a lower perspective view of the lithium rechargeable battery in accordance with another exemplary embodiment of the present invention, and FIG. 4c is a front view of FIG. 4a. Since the embodiment of FIG. 4a is substantially identical with that of FIG. 3a except for the fact that the embodiment of FIG. 4 has a lateral recess, a description follows only on the differences therebetween.

Referring to FIG. 4a, the lithium rechargeable battery 400 in accordance with another exemplary embodiment of the present invention includes a bare cell 405, a top cover 480 and an insulating layer 490. Since the top cover 480 and the insulating layer 490 have been described sufficiently in the embodiment of FIG. 2a, a detailed description thereof has been omitted.

The bare cell 405 includes an electrode assembly, a can and a cap assembly. The bare cell 405 is formed in a substantially elliptic cylindrical shape as the short lateral sides are formed in a smooth curved surface. The bare cell 405 can be formed having a horizontal section of a substantially rectangular shape as the long lateral sides and the short lateral sides are formed in a substantially plane shape, the same as the embodiment of FIG. 2a. That is, the embodiment of FIG. 2a or the embodiment of FIG. 3a may be selectively applied to the embodiment of FIG. 4a. Since the electrode assembly and the cap plate have been described sufficiently in the embodiment of FIG. 2a, a detailed description thereof has been omitted.

The can is formed in a cylindrical shape with a corner of a substantially elliptical shape, including a pair of long lateral sides opposite to each other in a substantially rectangular plane shape, a pair of short lateral sides opposite to each other in a curved surface shape, and a lower plate in an elliptical shape. The can can also be formed in a substantially rectangular box shape including a pair of long lateral sides opposite to each other in a substantially rectangular plane shape, a pair of short lateral sides opposite to each other in a substantially rectangular plane shape, and a lower plate in a rectangular shape. A bottom groove 492 and an insulating layer 490 are formed on the bottom surface of the can and a lateral recess 494 is arranged on the lateral side of the can.

The lateral recess 494 is arranged on the outer circumferential surface of the bare cell 405 to provide a space onto which a label is adhered. If the label is adhered thereto without forming the lateral recess 494, the label is difficult to be fixed on the bare cell 405 and further protrudes externally due to its thickness. The lateral recess 494 is formed stepped with the upper and lower parts of the can. That is, the lateral recess 494 is established over the whole outer circumferential surface except for the upper and lower parts of the can. Upper and lower ends of the lateral recess 494 are formed parallel to each other when viewing from the front; however, the front shape of the lateral recess 494 is not limited thereto. Moreover, the lateral recess 494 can be formed about 0.05 to 0.2 mm in depth; however, the depth of the lateral recess 494 is not limited thereto but can be varied according to the thickness of the label. The lateral recess 494 is arranged on the lateral side of the bare cell 405 so that the label does not protrude externally but is fixed on the outer circumferential surface, thus providing a sleek appearance.

Next, a method of fabricating the lithium rechargeable battery in accordance with the exemplary embodiments of the present invention is described. A description of an example of the lithium rechargeable battery in accordance with the exemplary embodiment of FIG. 4a follows.

The method of fabricating the lithium rechargeable battery 400 in accordance with the exemplary embodiment of the present invention includes the steps of: forming bottom grooves 492 for facilitating insertion and extraction to and from the equipment on the bottom surface of a can; forming a lateral recess 494 on the lateral side of the can; forming an electrode assembly; inserting the electrode assembly into a top opening of the can; sealing the top opening of the can with a cap assembly; injecting an electrolyte into an electrolyte injection hole; pressing in the electrolyte injection hole by means of a ball and welding the same; forming a top cover 480; and forming an insulating layer 490. Since the steps of forming the electrode assembly, inserting the electrode assembly, sealing the can, injecting the electrolyte, and pressing and welding the electrolyte injection hole are substantially identical with the general method of fabricating the lithium rechargeable battery, a detailed description thereof has been omitted.

The bottom grooves 492 are arranged on the bottom surface of the can to facilitate insertion and extraction to and from the equipment. It is desirable for the bottom grooves 492 to be formed by a pressing process; however, the process of forming the bottom grooves 492 is not limited thereto.

The lateral recess 494 is formed on the lateral side of the can to which a label is adhered. It is desirable for the lateral recess 494 to also be formed by a pressing process; however, the process of forming the lateral recess 494 is not limited thereto. The lateral recess 494 can be formed about 0.05 to 0.2 mm in depth.

The top cover 480, including a protection circuit, is arranged on the top of the bare cell 405. It is desirable for the top cover 480 to be formed by an injection molding process using a hot-melt resin; however, the process of forming the top cover 480 is not limited thereto.

The insulating layer 490, of an insulating material, is coated on the bottom surface of the bare cell 405 on which the bottom grooves 492 are provided. As the insulating material, various materials having an insulating property such as paint, plastic, rubber, etc. are available. It is desirable for the insulating layer 490 to be formed by a spray process or a dipping process; however, the process of forming the insulating layer 490 is not limited thereto. Moreover, it is preferable for the insulating layer 490 to be formed as a thin film layer so as not to affect the thickness of the lithium rechargeable battery 400.

According to the can for a lithium rechargeable battery and the lithium rechargeable battery using the can and a method of fabricating the can in accordance with the present invention, the capacity of the battery is increased by eliminating the existing bottom cover and forming a thin insulating layer on the bottom surface of the can to extend the vertical length of the battery.

According to the present invention, there is provided an effect of facilitating the adhesion of the label on the lateral side of the can and providing a sleek appearance by establishing a lateral recess on the lateral side of the can.

As described above, exemplary embodiments of the present invention have been disclosed through the descriptions and the drawings. The terms are used not to define the meanings thereof or restrict the scope of the present invention described in the claims but rather to explain the present invention. Therefore, it would be appreciated by those skilled in the art that modifications can be made to these embodiments without departing from the principles and spirit of the present invention, the scope of which is defined by the following claims.

What is claimed is:

1. A battery can comprising:
a predetermined space for accommodating an electrode assembly through a top opening of the can, the electrode assembly including a positive plate, a negative plate and a separator arranged between the positive plate and the negative plate; and
at least one bottom groove for facilitating insertion and extraction to and from equipment, the at least one bottom groove being arranged on a bottom surface of the can.

2. The battery can as recited in claim 1, wherein the at least one bottom groove is arranged in parallel to a long edge of the can.

3. The battery can as recited in claim 1, further comprising long lateral sides, short lateral sides and a lower plate and has a box shape.

4. The battery can as recited in claim 3, wherein a horizontal section of the can has an elliptical shape with the short lateral sides having a curved surface shape.

5. The battery can as recited in claim 1, further comprising a lateral recess arranged on a lateral side of the can to receive a label.

6. The battery can as recited in claim 5, wherein the lateral recess has a depth in a range of 0.05 mm to 0.2 mm.

7. The battery can as recited in claim 5, wherein the lateral recess is stepped with respect to upper and lower parts of the can.

8. A battery comprising:
a bare cell including an electrode assembly, a can to accommodate the electrode assembly and a cap assembly to seal a top opening of the can;
a hot-melt section including a protection circuit electrically connected to the bare cell; and
an insulating layer coated on a bottom surface of the bare cell, the insulating layer including an insulating material.

9. The battery as recited in claim 8, wherein the hot-melt section is arranged on the top of the bare cell to serve as a top cover.

10. The battery as recited in claim 8, wherein the insulating layer is coated on a bottom surface of the bare cell by either a spray process or a dipping process.

11. The battery as recited in claim 8, further comprising at least one bottom groove arranged on a bottom surface of the bare cell to facilitate insertion and extraction to and from equipment.

12. The battery as recited in claim 11, wherein the at least one bottom groove is arranged in parallel to a long edge of the can.

13. The battery as recited in claim 8, further comprising a lateral recess arranged on a lateral side of the can to receive a label.

14. The battery as recited in claim 13, wherein the lateral recess has a depth in a range of 0.05 mm to 0.2 mm in depth and is stepped with respect to upper and lower parts of the can.

15. A method of fabricating a battery comprising:
forming a bottom groove on a bottom surface of a can to facilitate insertion and extraction to and from equipment;
inserting an electrode assembly including a bare cell into an inside of the can;
injecting an electrolyte into the inside of the can;
forming an insulating layer on the bottom surface of the can; and
forming a hot-melt section on a top of the can to seal the can, the hot-melt section including a protection circuit electrically connected to the bare cell.

16. The method as recited in claim 15, further comprising forming a lateral recess on a lateral side of the can to receive a label.

17. The method as recited in claim 15, wherein forming an insulating layer comprises either a spray process or a dipping process.
